(19) United States
(12) Patent Application Publication
(10) Pub. No.: US 2021/0016806 A1
(43) Pub. Date: Jan. 21, 2021

(54) DEVICE AND METHOD FOR CONVERTING A DIESEL-ELECTRIC LOCOMOTIVE INTO AN ELECTRIC LOCOMOTIVE

(71) Applicant: SIEMENS MOBILITY GMBH, MUENCHEN (DE)

(72) Inventors: STEFAN HINTERMEIR, ASCHAU I. CH (DE); ANDREAS HAERER, UTTENREUTH (DE)

(21) Appl. No.: 16/980,512

(22) PCT Filed: Jun. 28, 2018
(86) PCT No.: PCT/EP2018/067501

§ 371 Date: Sep. 14, 2020

(30) Foreign Application Priority Data
Mar. 13, 2018 (DE) 102018203730

(51) Int. Cl. B61C 17/12; B61C 3/00; B61C 7/04

(52) U.S. Cl. CPC B61C 17/12; B60L 2200/26; B61C 7/04; B61C 3/00

(57) ABSTRACT

A device for converting a diesel-electric locomotive into an electric locomotive includes operating components for an electric locomotive and an adapter frame on which the operating components are mounted. The adapter frame is designed so that it can be connected to connection points of a mechanical basic structure of the diesel-electric locomotive. There is also described a corresponding electric locomotive and a method for conversion.

The invention relates to a device and a method for converting a diesel-electric locomotive into an electric locomotive, and to such a converted electric locomotive.

Due to the increasing prices of diesel, there is in particular in countries with a very great number of diesel-electric locomotives the need for electrification of the lines. Since, however, the existing diesel-electric locomotives are generally still usable, conversion of these diesel-electric locomotives into electric locomotives is of advantage.

There have so far been few cases in which diesel-electric locomotives have been converted into electric locomotives. For such a conversion, the basic mechanical structure, such as the body or undercarriage, the bogie with the drives (traction motor and transmission), the driver's cab with operating elements and comfort-enhancing equipment and braking equipment can generally continue to be used.

By contrast, the diesel engine with flange-mounted generator, the associated cooling system, air treatment unit and exhaust muffler as well as braking resistors and other auxiliary installations, along with the existing drive converters, are removed.

For use as electric locomotives, high-voltage components, the transformer, the static power converter with its part on the network side and its part on the traction-motor side, and an associated cooling system and auxiliary power converter, must then be newly installed in the components that continue to be used. Generally, the installed components are arranged individually on the undercarriage of the stripped-down locomotive, assembled and the necessary connections to one another and to components of the locomotive are made by way of cables and tubes.

This conversion is very laborious and cost-intensive. Moreover, it is not easily possible to check the interaction between the components before the conversion is completed. This represents a commercial disadvantage.

It is therefore an object of the present invention to provide a device and a method for converting a diesel-electric locomotive and also such a converted electric locomotive that overcome the disadvantages of the prior art and allow improved conversion.

This object is achieved by a device according to patent claim 1, by a method according to patent claim 13 and by an electric locomotive according to patent claim 12.

A device according to the invention (“electro power pack”) for converting a diesel-electric locomotive into an electric locomotive comprises the following components:

Operational Components for an Electric Locomotive

These are those components that are responsible for the drive of an electric motor according to the principle of an electric locomotive and are normally housed in the engine compartment of an electric locomotive. The operational components may also be referred to as “essential components” of an electric locomotive and they essentially comprise the electrical switching, controlling and transmitting systems of an electric locomotive.

Since one or more traction motors (electric motors) are normally already contained in diesel-electric locomotives, they are preferably not included in the device. The traction motors at least do not form part of the operational components.

An Adapter Frame

This adapter frame is a stable frame, for example made of steel, on which the operational components are mounted. It ensures stable standing on a base and stable fastening of the operational components, so that the device can preferably be put together outside a locomotive and easily lifted into the locomotive to be converted by raising the adapter frame. For this purpose, the adapter frame should have a corresponding rigidity. Moreover, the adapter frame should be designed such that the device does not tip over when the operational components are assembled on the adapter frame. In this respect, it is of advantage if it is wider (at least in the region below the respective operational components) than the respective operational components.

In the context of the invention, the adapter frame is designed such that it can be connected to connection points, that is to say for example generator connection points and/or diesel-engine connection points, of a basic mechanical structure of the diesel-electric locomotive, that is to say for example an undercarriage.

The adapter frame preferably has a rectangular basic form. Depending on the geometrical specifications dictated by the substructure of the locomotive to be converted, it may however be required or advantageous that the adapter frame deviates from the rectangular basic form. If, for example, a rib is present in the substructure, in order to stabilize it, this rib should not be removed, but instead the adapter frame should be correspondingly shaped at the corresponding locations, for example by cutouts or constrictions. The adapter frame may also have protuberances at certain locations on the sides, in order for example to be able to establish a better connection to a connection point of a substructure or to an operational component.

The adapter frame may have holding structures and/or be made higher in some regions than in other regions. This is advantageous for example whenever connection points lie higher than other locations in the basic structure of the diesel-electric locomotive and an operational component that is wider than the distance between these higher connection points is to be arranged in this region. This operational component can then be mounted on the adapter frame such that it is elevated to the extent that it lies over the higher connection points. Preferably, the adapter frame comprises a rectangular basic body and holding structures, which are advantageously formed as fastening structures and/or shimming structures.

There are various types of diesel-electric locomotives that can be converted by means of the invention. Two types by way of example are the type EMD GT46MAC (in India also known as WDG 4) or GT42CUAC Class 4000 (also known as Class PN) from Clyde/GM. The adapter frame is preferably designed such that it can be mounted on the basic structure of one type or even both types.

The length of the adapter frame should be shorter than the basic structure of the diesel-electric locomotive to be converted, in particular at least 2 m shorter. Preferably, the adapter frame is shorter than 18 m, in particular shorter than 13 m, particularly preferably shorter than 7 m. A short form of construction has the advantage that less structural rigidity is necessary. However, it should provide space for all of the desired or necessary operational components. Therefore, the adapter frame has a length of at least 2 m, preferably of at least 4 m, particularly preferably of at least 6 m.

The width of the adapter frame often depends on the position of the connection points and the form of the basic structure of the diesel-electric locomotive to be converted. Preferably, the width of an essential part of the adapter frame (in particular of the basic body) is at least 40 cm, preferably at least 60 cm, particularly preferably at least 80 cm. Preferably, the width of the essential part of the adapter frame (in particular of the basic body) is a maximum of 120 cm, preferably a maximum of 100 cm, particularly preferably a maximum of 90 cm. Preferably, the maximum width of the adapter frame (in particular its holding structures) is a maximum of 200 cm, preferably a maximum of 160 cm, particularly preferably a maximum of 140 cm.

An electric locomotive according to the invention comprises a device according to the invention.

A method according to the invention for converting a diesel-electric locomotive into an electric locomotive comprises the following steps:
Providing a device according to the invention outside the diesel-electric locomotive. This allows easy assembly of the operational components on the adapter frame. Moreover, it is easily possible to test the operational components on the adapter frame.

A test of the device, in particular a mechanical and/or an electrical test and also a test of a cooling system or a cooling circuit or a brake pressure generator, represents a preferred additional step.
Mounting the device on a basic mechanical structure of the diesel-electric locomotive. For example, the device may be lifted onto a substructure of a locomotive by means of a crane.
Connecting the device to connection points of the basic mechanical structure. The device is therefore fastened on the basic structure by means of this connection, so that it could also be said that the fastening of the device takes place on the connection points of the basic mechanical structure. Many types of connection are possible for this. Screwing is preferable, since it allows a subsequent correction and mechanical stresses can be relieved.
Energy-related connection of the device to drive components of the diesel-electric locomotive. In this step, for example, the operational components are electrically connected to traction motors (electric motors) of the locomotive, so that they can be supplied with power by the corresponding operational components. Here, too, a control-related connection may for example be made to control components of the locomotive or a hydraulic or pneumatic connection of a brake pressure generator may be made to a brake.

The invention is therefore in particular concerned with integrating the essential components, the transformer, static power converter, cooling system and auxiliary power converter (and possibly brake pressure generator) in a device (“electro power pack”), such that they can be assembled on an adapter frame outside the diesel-electric locomotive to be converted, connected by cables and tubes or hoses, put into operation and tested. After the test, the complete device (“electro power pack”) can then be placed as a unit on the locomotive and connected to a small number of locomotive interfaces (for example control interfaces, traction motor, brake).

Further, particularly advantageous refinements and developments of the invention emerge from the dependent claims and from the following description, while the claims of one category of claims may also be developed analogously to the claims of another category of claims and the relevant parts of the description, and in particular individual features of different exemplary embodiments or variants may also be combined to form new exemplary embodiments or variants.

Preferably, the operational components arranged on the adapter frame are designed such that they can drive traction motors of the diesel-electric locomotive if they are equipped with or connected to an energy source. This has the advantage that in principle no further functional components are required for the conversion.

The operational components, that is to say the electric-locomotive-specific assemblies, in this case preferably comprise electrical, switching and/or controlling and/or transmitting systems, particularly preferably components of the group comprising the transformer, static power converter, cooling system and auxiliary power converter, brake pressure generator, current collector and charge storage unit.

According to a preferred embodiment, a transformer, a static power converter, an auxiliary power converter and in particular a cooling system and/or a brake pressure generator are assembled on the adapter frame. It goes without saying, however, that other configurations of the electric-locomotive-specific assemblies, for example other groupings or other positionings, can also be provided. In the case of a diesel-electric locomotive, generally not only traction motors are already present, but also the brakes. However, it could be necessary also to change the compressed air generator unit. In this case, the operational components arranged on the adapter frame also comprise a brake pressure generator. This may be for example a compressed air generator unit or else a liquid pressure generator.

The sequence of the operational components in the device is preferably dictated by the energy flow. A current collector is preferably mounted next to a main switch, which is preferably next to a transformer, which in turn is preferably next to a static power converter.

The cooling system preferably comprises an oil cooler for the transformer and a water cooler (or possibly an air cooler) for a static power converter. A combined cooler is preferred here. In the case of a combined cooler, for example, air from outside flows through a water cooling plate and is then forced through an oil cooling plate. Therefore, only one air stream is required to cool the transformer and the converter simultaneously.

Preferably, the operational components are functionally connected to one another on the adapter frame. The term “functionally” means here that the connection has the aim of achieving a function, for example an energy-related, cooling-related, control-related or data-related function. Preferably, the device comprises for this purpose electrical connections (for example between energy-related components such as the transformer, static power converter or auxiliary power converter, but also for relaying signals), hydraulic connections (between the cooling system and cooling regions of the other components) or pneumatic connections (included in braking equipment). The preferred “electro power pack” therefore preferably has all of the electrical, hydraulic and pneumatic connections between the operational components (for example the transformer, static power converter, cooling system and auxiliary power converter, brake pressure generator) integrated in it.

Preferably, all of the interfaces from the device to the rest of the locomotive (that is to say for example data interfaces for the driver's cab, electrical connections to traction motors, possibly contacts with current collectors, brake lines) are positioned at suitable positions on the device. The “electro power pack” is consequently a pre-testable unit, which can be electrically, hydraulically and pneumatically tested in advance and logged. The device preferably has mountings for interfaces or collecting points for interfaces for the locomotive to be converted, at which for example cables, tubes, hoses, bushings or connectors can be fastened.

In the case of diesel-electric locomotives, a driver's cab is usually already present. However, depending on the application, it may be necessary or advantageous to replace the driver's cab and/or to add a further driver's cab, for example at the opposite end of the locomotive. In this case, it is preferred that at least one driver's cab is arranged on the adapter frame in addition to the operational components, preferably at a (longitudinal) end of the adapter frame. The driver's cab arranged on the adapter frame is preferably (already) connected electrically and in a data-related respect to the operational components arranged on the adapter frame.

Preferably, the device comprises frame connections on the adapter frame. These are elements for connecting the adapter frame to connection points of the basic mechanical structure of a diesel-electrical locomotive. The connection points are generally generator connection points and diesel-engine connection points, that is to say those locations at which the generator and the diesel engine were fastened in the diesel-electric locomotive before the conversion. The adapter frame may therefore be connected or fastened at the generator connection points and diesel-engine connection points by the frame connections. Other fastening possibilities, for example welding or screwing on directly (at other locations), may be chosen according to the application.

In the case of a diesel-electric locomotive, connection points may be present both at the same height and at different heights. A conceivable difference in height could lie in the range of 200 mm. The adapter frame may therefore also be designed in a stepped manner, preferably at the locations by which it is to be fastened at the connection points. Alternatively or in addition, the frame connections preferably comprise flange plates to compensate for these differences in height. The flange plates preferably have for this purpose compensating holes, which are at least 1.5 times larger than the elements used for fastening (for example screws). During fastening, a plate is preferably arranged over the holes instead of a shim, in order that the fastening elements (for example screws) do not slip through.

Preferably, the device additionally comprises elastic mounts, for example spring elements, in particular made of steel or rubber, in the region in which the adapter frame is connected to connection points.

Preferably, the adapter frame is designed such that it can be mounted on the basic mechanical structure of a number of types of diesel-electric locomotives. The adapter frame is in this case preferably designed such that it can be connected to connection points of these types of diesel-electric locomotives. Should the different types each have connection points at different positions, the adapter frame is preferably designed such that it can always be fastened at the respective (different) connection points. Such an adapter frame has the advantage that the design of the device can be easily adapted to different types of diesel-electric locomotives or the device can be used without modifications for the conversion of a number of types of diesel-electric locomotives.

Preferably, the adapter frame provides mechanical connection points according to the prior art for all of the components of the device (of the “electro power pack”). For example, at predetermined locations in the adapter frame there are holes at which the operational components can be screwed. It is in this case preferred that the adapter frame has differently positioned groups of connection points at at least one position for an operational component, so that a number of types of an operational component (for example different types of transformer) can be connected to the adapter frame.

Preferably, the operational components comprise integral structures, preferably an auxiliary power converter together with a static power converter (the auxiliary power converter may in this case be integrated in particular in the static power converter) and/or a transformer together with a cooling system and/or a current collector together with a transformer and/or a transformer together with a static power converter. Therefore, two or more of the operational components take the form of a functionally interacting unit.

Preferably, the adapter frame has lifting fastening units, which are designed such that hooks of a crane suspension can be connected to the adapter frame. These lifting fastening units are preferably lifting lugs, lifting eyes or corresponding formations or cutouts in the adapter frame. For example, the adapter frame may have threaded holes, in which eyelets can be screwed. The lifting fastening units may however also be welded on. The lifting fastening units have the advantage that the complete “electro power pack” can be raised up in its entirety into the locomotive and connected there.

Preferably, the device is designed such that it can be put into operation and tested as a system outside the diesel-electric locomotive.

Preferably, the adapter frame comprises ballast and/or trimming ballast. Alternatively or in addition, the adapter frame is designed such that it acts as ballast and/or trimming ballast. Since experience shows that the equipment of diesel-electric locomotives is heavier than that of electric locomotives, it is of advantage if the adapter frame acts as ballast and trimming ballast.

Preferably, the adapter frame is of a two-part configuration. In this case, the individual parts can in particular be connected to one another. This is of advantage if the total weight of the “electro power pack” should happen to be too great (for example for a crane, for transporting, etc.). Also for the case where the connection points of the diesel-electric locomotive are not compatible with the connection points of the components of the electric locomotive, the adapter frame may be of a two-part configuration. If, however, there are no reasons for it not to be, the adapter frame is particularly preferably always designed as one part, but may comprise a number of components fixedly joined together.

Preferably, the device is designed such that it at least partially has the outer form of the construction of an electric locomotive, preferably the roof structure and/or the side walls (in particular in the form of a “narrow hood”). In this case, the operational components placed onto the adapter frame preferably form at least partially the outer skin of the vehicle. Since experience shows that conversions of diesel-electric locomotives into electric locomotives are accompanied by alterations in the side-wall region and roof region, side-wall modules and roof modules may therefore likewise be integrated in the “electro power pack”, which further reduces the conversion time.

It is preferred that a closing system (for example a barrier system with respect to the high-voltage region) is integrated in the device. Depending on the application, the device may also have a passageway, for example a central passageway.

Preferred is a method in which, to produce the device, operational components of an electric locomotive are assembled on an adapter frame and this adapter frame is preferably provided with frame connections for connecting to the connection points of the basic mechanical structure of the diesel-electric locomotive.

Preferred is a method in which, before the energy-related connection of the device to drive components (for example a traction motor of the locomotive), in particular before the mounting of the device on the basic mechanical structure, the device is tested for its function.

The invention has the advantage that the assembly of the device can take place outside a locomotive, which is much easier than assembling the operational components on the locomotive. Moreover, the device may be put into operation and tested outside a locomotive. The device then only has to be placed as a unit onto a locomotive and connected to a small number of interfaces. These points reduce the conversion time considerably.

Furthermore, constructing the operational components on the adapter frame allows the mechanical installation points to be reduced, so that the given tolerances of the undercarriage of the diesel-electric locomotive can be compensated better. In principle, only the connection points that are present in any case have to be used, and not even all of these.

The invention is explained once again in more detail below on the basis of exemplary embodiments with reference to the appended figures. The same components are provided with identical designations here in the various figures. In the figures, which are generally not to scale:

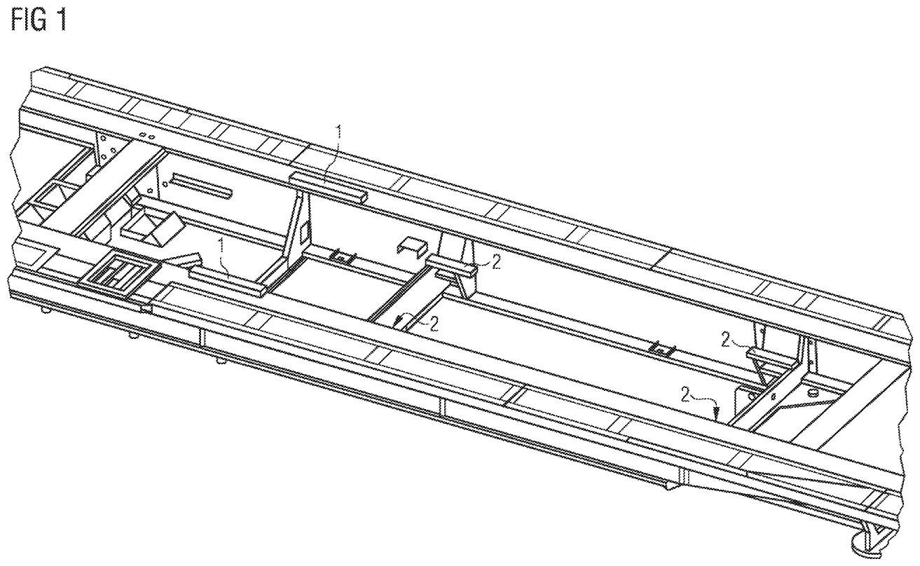

FIG. 1 shows an example of an undercarriage of a diesel-electric locomotive,

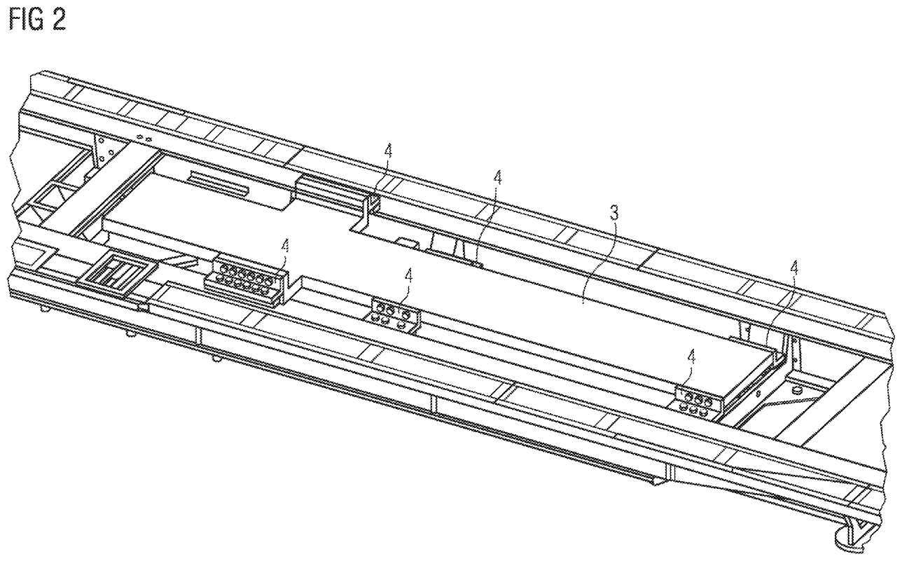

FIG. 2 shows an example of an undercarriage of a diesel-electric locomotive with an adapter frame.

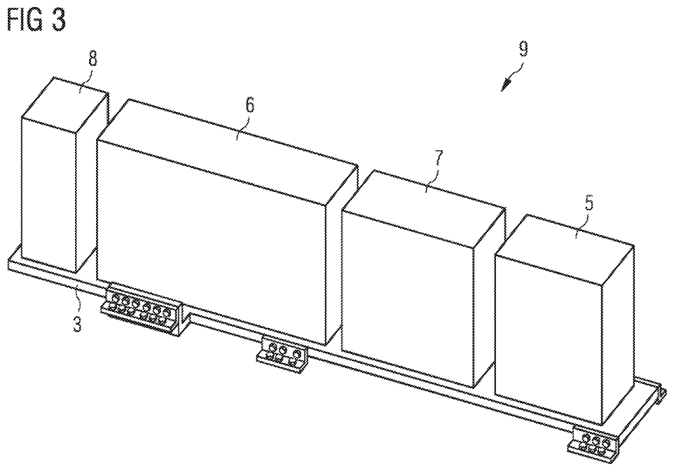

FIG. 3 shows an example of a device according to the invention,

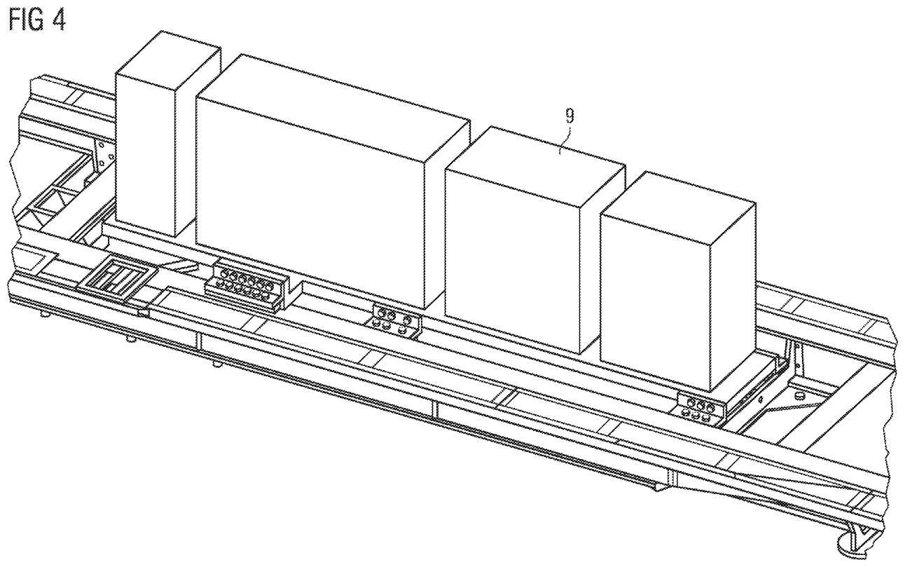

FIG. 4 shows an example of an undercarriage of a converted diesel-electric locomotive,

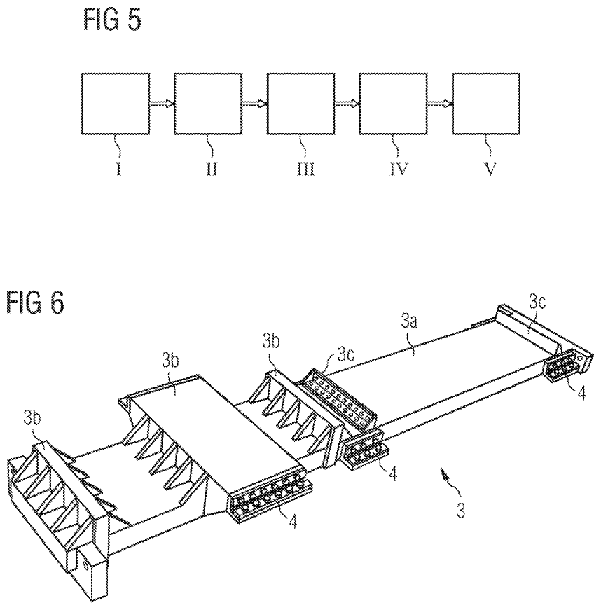

FIG. 5 shows an exemplary embodiment of a method according to the invention,

FIG. 6 shows an example of an adapter frame.

FIG. 1 shows by way of example an undercarriage of a diesel-electric locomotive which is to be converted into an electric locomotive. This undercarriage is representative of a basic mechanical structure with a body or undercarriage with a bogie with the drives (traction motors and transmission). There may likewise be a driver's cab with operating elements and comfort-enhancing equipment and the braking equipment of the diesel-electric locomotive.

The undercarriage shown here for a diesel-electric locomotive comprises four diesel-engine connection points 2 (two are concealed because of the perspective) and two generator connection points 1. The number and position of the connection points 1, 2 depend on the type of locomotive and also the diesel-electric drive units mounted there. Other diesel engines with generators have for example a different number of connection points.

FIG. 2 shows an example of an undercarriage of a diesel-electric locomotive with an adapter frame 3. This is fastened at the generator connection points 1 and the diesel-engine connection points 2. In this example, the adapter frame 3 was connected by means of screwing at the generator connection points 1 and diesel-engine connection points 2 by frame connections 4. Other possibilities for fastening, for example welding or screwing on directly without frame connections 4, may be chosen according to the application.

This figure is not intended to describe the invention directly, but merely illustrates the concept of the fixed and secure connection of the adapter frame 4 to the undercarriage. Presented hereafter is a device according to the invention that can be connected by means of its adapter frame to the undercarriage in the way shown here.

FIG. 3 shows an example of a device 9 according to the invention. According to the invention, the operational components 5, 6, 7, 8, that is to say the electric-locomotive-specific assemblies, are assembled on the adapter frame 3. In the example shown, these are the transformer 5, static power converter 6, cooling system 7 and auxiliary power converter 8. It goes without saying that other configurations of the operational components 5, 6, 7, 8, for example other groupings or other positionings, may be provided. The assembled device 9 shown here, comprising the adapter frame 3, transformer 5, static power converter 6, cooling system 7 and auxiliary power converter 8, may also be referred to as an “electro power pack” 9.

The adapter frame 3 is created here in such a way that it provides mechanical connection points (possibly according to the prior art) for all of the components of the device 9. Moreover, all of the electrical, hydraulic and pneumatic connections between the components, the transformer 5, static power converter 6, cooling system 7 and auxiliary power converter 8, are integrated in the device 9. All of the interfaces of the device 9 with the rest of the locomotive are positioned at suitable positions on the device 9. The device 9 is consequently a pre-testable unit, which can be electrically, hydraulically and pneumatically tested in advance and logged. Suitable lifting lugs or lifting eyes (not shown) allow the complete device 9 to be raised up as a unit onto the undercarriage, that is to say into the locomotive, and connected there.

FIG. 4 shows an example of an undercarriage of a converted diesel-electric locomotive, with an inserted device according to the invention as provided by the example shown in FIG. 3.

FIG. 5 shows an exemplary embodiment of a method according to the invention for converting a diesel-electric locomotive into an electric locomotive.

In step I, a construction or an assembly of a device 9 according to the invention takes place, as can be seen for example in FIG. 3. The assembly of the device 9 takes place in this case outside the diesel-electric locomotive. During the assembly of the device 9, operational components 5, 6, 7, 8 of an electric locomotive are assembled on an adapter frame 3, for example are screwed to it. The adapter frame 3 may be provided with frame connections 4 for connecting to connection points 1, 2 of a basic mechanical structure of the diesel-electric locomotive.

In step II, a test of the device (9) for its function is performed. In this case, for example, sensors may be connected to the interfaces of the device 9 and their states measured, while the device receives control signals such as it would also receive in practice from a driver's cab.

In step III, mounting of the device 9 on a basic mechanical structure of the diesel-electric locomotive takes place. For this purpose, lifting lugs may be attached to the adapter frame 3 (if there are not yet any lifting fastening units) and the adapter frame lifted by means of a crane onto the basic framework of the diesel-electric locomotive to be converted.

In step IV, the device 9 is connected to connection points 1, 2 of the basic mechanical structure, it is therefore fastened to the basic structure at the connection points 1, 2. The fastening is preferably performed by way of screwing.

In step V, an energy-related connection of the device 9 to drive components of the diesel-electric locomotive is performed.

FIG. 6 shows a preferred adapter frame 3. This adapter frame comprises a rectangular basic body 3a and holding structures 3b, 3c. Moreover, frame connections 4 are attached. Some of the holding structures 3b, 3c are shaped as shimming structures, in order to allow elevated mounting of an operational component 5, 6, 7, 8. Other holding structures are formed as fastening structures 3b, which are intended to hold a further operational component 5, 6, 7, 8 between them with a form fit.

Finally, it is once again pointed out that the device 9 previously described in detail merely comprises exemplary embodiments that can be modified in a wide variety of ways by a person skilled in the art without departing from the scope of the invention. Furthermore, the use of the indefinite article “a” or “an” does not exclude the possibility that the features concerned may also be multiply present. Similarly, the terms “unit” and “component” do not exclude the possibility that the elements concerned consist of multiple interacting part-segments, which may possibly also be spatially distributed.

1-15. (canceled)

16. A device for converting a diesel-electric locomotive to an electric locomotive, the device comprising:
an adapter frame upon which the operational components are mounted, said adapter frame being configured for connection to connection points of a basic mechanical structure of the diesel-electric locomotive;
operational components for the electric locomotive, said operational components being integral structures including an auxiliary power converter together with a static power converter, a transformer together with a cooling system, a current collector together with a transformer, and a transformer together with a static power converter;
said operational components being functionally connected to one another on said adapter frame, including electrical connections, hydraulic connections, and pneumatic connections between the transformer, the static power converter, the cooling system, and the auxiliary power converter;
the device being configured to be put into operation and to be tested as a system outside the diesel-electric locomotive;
the device, at least in part, having an outer shape of the electric locomotive, including a roof structure and side walls, and said operational components placed onto said adapter frame forming, at least in part, an outer skin of the locomotive.

17. The device according to claim 16, wherein:
said operational components arranged on said adapter frame are configured for driving at least one traction motor of the diesel-electric locomotive and said operational components are equipped with, or connected to, an energy source;
said operational components comprise electrical switching systems, controlling systems and transmitting systems selected from the group consisting of the transformer, the static power converter, the cooling system and auxiliary power converter, a brake pressure generator, a current collector, and charge storage unit.

18. The device according to claim 16, comprising frame connections on said adapter frame for connecting said adapter frame to connection points of a basic mechanical structure of the diesel-electrical locomotive.

19. The device according to claim 16, wherein said adapter frame is configured for mounting on a basic mechanical structure of a number of different types of diesel-electric locomotives and is configured for connecting to connection points of the different types of the diesel-electric locomotives.

20. The device according to claim 16, wherein said adapter frame is formed with lifting fastening units configured for engaging with hooks of a crane suspension.

21. The device according to claim 20, wherein said lifting fastening units are selected from the group consisting of lifting lugs and lifting eyes.

22. The device according to claim 16, wherein said adapter frame comprises ballast and/or trimming ballast.

23. The device according to claim 16, wherein said adapter frame is formed to act as a ballast and/or a trimming ballast.

24. The device according to claim 16, wherein said adapter frame has a two-part configuration with two to be connected to one another.

25. An electric locomotive, comprising a device according to claim 16.

26. A method of converting a diesel-electric locomotive into an electric locomotive, the method comprising the following steps:
providing a device according to claim 16 outside the diesel-electric locomotive;
functionally testing the device and subsequently mounting the device on a basic mechanical structure of the diesel-electric locomotive;
connecting the device to connection points of the basic mechanical structure;
connecting energy-related connections of the device to drive components of the diesel-electric locomotive.

27. The method according to claim 26, producing the device by assembling operational components of an electric locomotive on an adapter frame, wherein the adapter frame is provided with frame connections for connecting to the connection points of the basic mechanical structure of the diesel-electric locomotive.
